(19) United States
(12) Patent Application Publication
(10) Pub. No.: US 2023/0351184 A1
(43) Pub. Date: Nov. 2, 2023

(54) Query Classification with Sparse Soft Labels

(71) Applicant: Vui, Inc., Boston, MA (US)

(72) Inventors: Giuseppe Di Fabbrizio, Brookline, MA (US); Evgeny Stepanov, Povo (IT); Amirhossein Tebbifakhr, Trento (IT); Phil C. Frank, Cohasset, MA (US)

(21) Appl. No.: 17/731,309

(22) Filed: Apr. 28, 2022

(51) Int. Cl. G06N 3/08; G06F 16/242; G06K 9/62

(52) U.S. Cl. CPC G06N 3/082; G06F 16/243; G06K 9/6277; G06K 9/6259

(57) ABSTRACT

Data is received characterizing a plurality of search queries including user provided natural language representations of the plurality of search queries of an item catalogue and first labels associated with the plurality of search queries. Label weights characterizing a frequency of occurrence of the first labels within the received data is determined using the received data. Second labels are determined. The determining of the second labels includes removing or changing the first labels from the received data to reduce a total number of allowed labels for at least one search query. A classifier is trained using the plurality of search queries, the second labels, and the determined weights. The classifier is trained to predict, from an input search query, a prediction weight and at least one prediction label associated with the prediction weight. Related apparatus, systems, techniques, and articles are also described.

### TECHNICAL FIELD

The subject matter described herein relates to query classification with sparse soft labels.

### BACKGROUND

When looking for a specific product on an e-commerce website, a user may enter a search query representing a short description of the searched for product. Depending on the relevance of search engine results relative to the user's original intent, the user can select a matching product by clicking on a graphical user interface (GUI) object associated with the product, reformulate the query to adjust the results, or abandon the site (e.g., if the relevance of the returned products is far from the expected accuracy).

### SUMMARY

In an aspect, data is received characterizing a plurality of search queries including user provided natural language representations of the plurality of search queries of an item catalogue and first labels associated with the plurality of search queries. Label weights characterizing a frequency of occurrence of the first labels within the received data is determined using the received data. Second labels are determined. The determining of the second labels includes removing or changing the first labels from the received data to reduce a total number of allowed labels for at least one search query. A classifier is trained using the plurality of search queries, the second labels, and the determined weights. The classifier is trained to predict, from an input search query, a prediction weight and at least one prediction label associated with the prediction weight.

One or more of the following features can be included in any feasible combination. For example, the determining the second labels can include determining a probability distribution of the second labels. Training the classifier can include using the probability distribution. The item catalogue can categorize items by a hierarchical taxonomy. The first labels can be categories included in the item catalogue. The first labels can be determined based on user behavior associated with the plurality of search queries.

The categories in the item catalogue can be pruned to limit the number of allowed labels. The pruning can be based on a count of the labels occurring within the received data. Determining the second labels can include applying a sparsity constraint to the first labels. Applying the sparsity constraint to the first labels can include computing a metric and removing or changing labels within the first labels that satisfy the metric. The second labels can be represented as a sparse array.

The received data can be split into at least a training set, a development set, and a test set. Training the classifier can include determining, using a natural language model, contextualized representations for words in the natural language representation, tokenizing the contextualized representations, and wherein the training the classifier is performed using the tokenized contextual representations. The tokenized contextual representations can be input to a multilayer feed forward neural network with a nonlinear function in between at least two layers of the multilayer feed forward neural network. The training can further include determining a cost of error measured based on a distance between labels within a hierarchical taxonomy.

An input query characterizing a user provided natural language representation of an input search query of the catalog of items can be received. A second prediction weight and a second prediction label can be determined using the trained classifier. The input query can be executed on the item catalogue and using the second prediction weight and the second prediction label. Results of the input query execution can be provided.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 shows three examples of search queries and related taxonomy labels associate with each query in case the label selection is done by a majority vote;

FIG. 2 shows the search queries and related taxonomy labels illustrated in FIG. 1, and further includes categories that are selected less frequently;

FIG. 3 illustrates an example taxonomy as a tree-structure, where nodes form categories, and label occurrence count is illustrated below several leaf nodes;

FIG. 4 is an example learning architecture for determining output distribution from search queries where the learning architecture includes a DistilBERT transformer;

FIG. 5 is a process flow diagram illustrating an example process of training a query classifier that utilizes sparse soft labels and can improve query label prediction;

FIG. 6 is a system block diagram illustrating an example ecommerce search system according to some examples of the current subject matter; and

FIG. 7 illustrates an example conversational system that can utilize a classifier trained according to some implementations of the current subject matter to perform queries of an item catalogue.

Like reference symbols in the various drawings indicate like elements.

### DETAILED DESCRIPTION

Manually categorizing user queries into product categories can be hard and time-consuming due to the difficulty of interpreting user intentions based on a short query text and the number of categories (e.g., classification classes) present in an e-commerce catalog. For example, in some e-commerce catalogues, the number of categories can easily reach several thousand. However, if a user selects a product by clicking soon after a list of products is returned as a result of a search, the category of the selected product can be considered as an accurate, although sometimes noisy, indication of the category label associated with the query. Additionally, if the same search query is used by several users during a reasonable time interval (e.g., 30-90 days) and the users provide a minimum number of clicks (e.g., more than 10 clicks) of products with the same category label, the selected category can be considered as a valid label for the query.

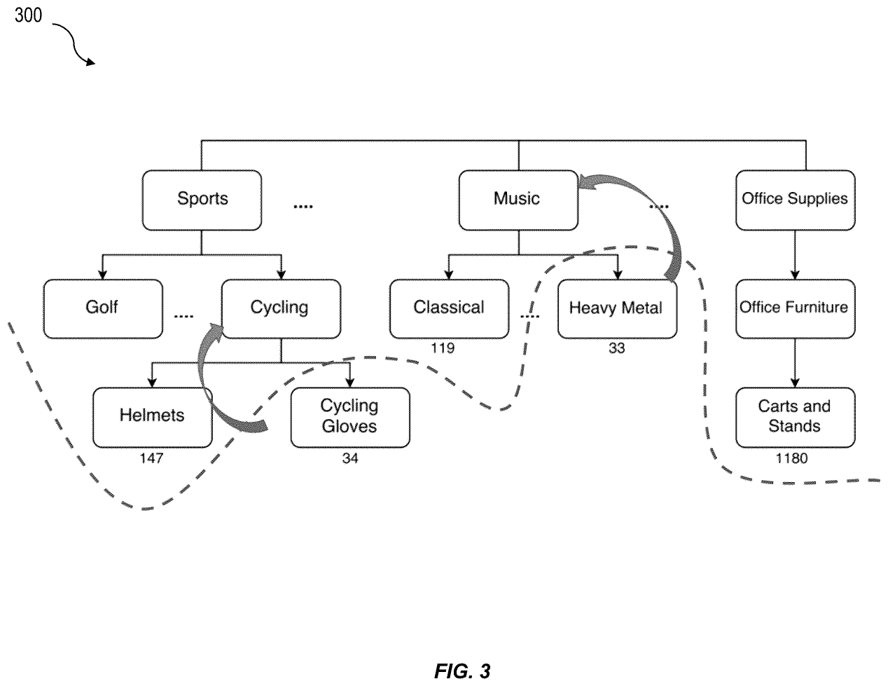

Using behavioral signals such as clicks, add-to-cart, and check-outs is a practical way to automatically generate category labels. Annotating query classification datasets using behavioral signals can also imply that a given query can have a certain percentage of interactions with multiple taxonomy labels (e.g., catalog product categories, an example subset of a hierarchical taxonomy is illustrated in FIG. 3 and described in more detail below). User interaction with multiple product categories can be represented as a probability distribution over the labels that belong to a given query. By setting the problem as a standard multi-class problem, each label can be considered independent from the others, and, since they cannot occur at the same time, each of them has a probability of zero or one (e.g., in the training dataset). But such an approach is inaccurate since it ignores the ambiguous nature of search queries, which can belong to several taxonomy category labels at the same time.

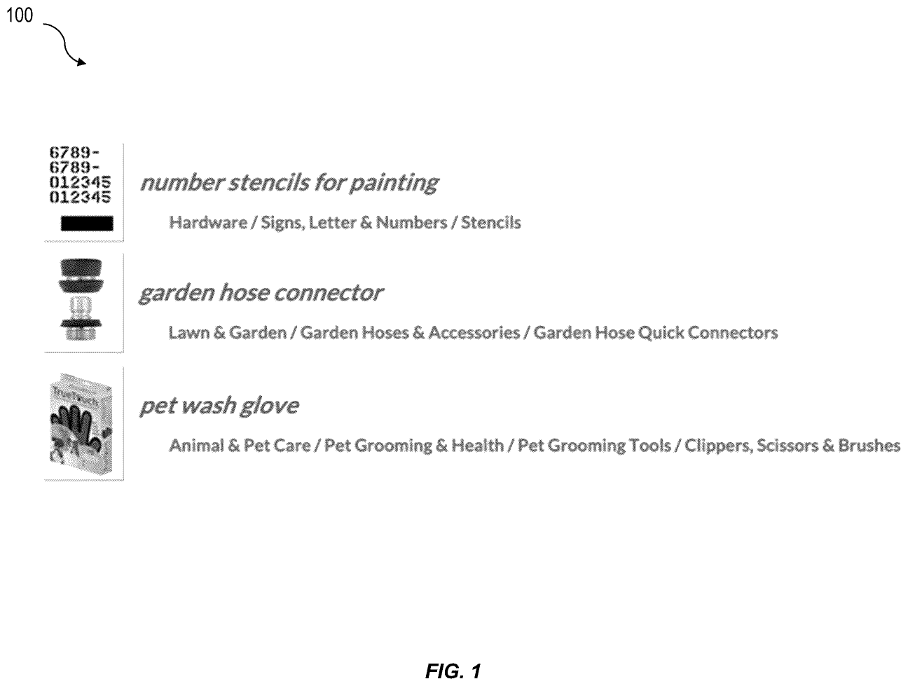

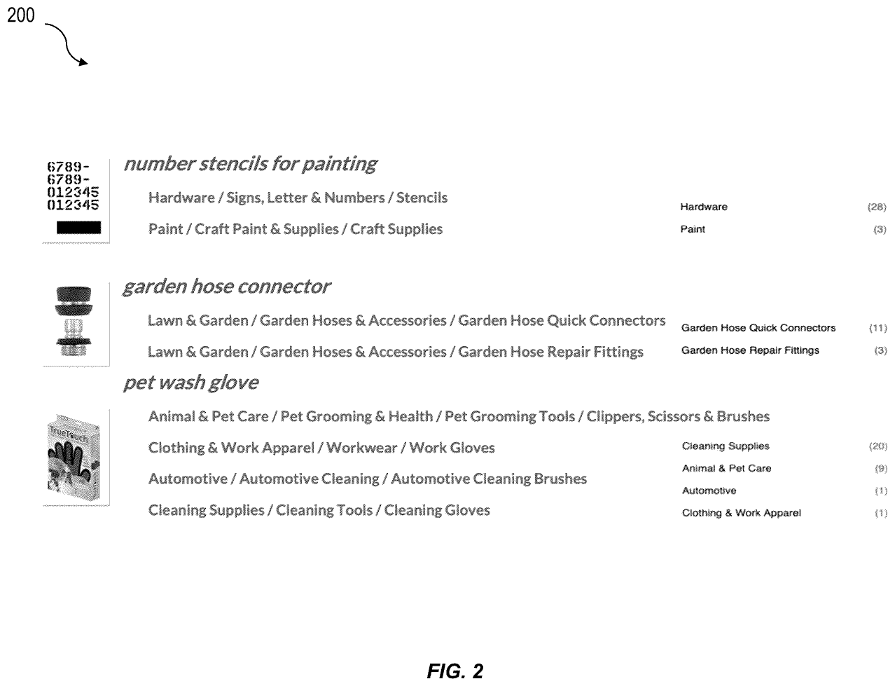

FIG. 1 shows three examples 100 of search queries and related taxonomy labels associate with each query in case the label selection is done by a majority vote (e.g., the highest number of category clicks received by the query). For instance, the query “number stencils for painting” belongs to the category “Stencils” that is at the third level of the taxonomy tree, under “Sign, Letter & Numbers” and “Hardware”. In some implementations of the current subject matter, the interaction of a query with other labels in the taxonomy tree can be taken into consideration. FIG. 2 shows the search queries and related taxonomy labels illustrated in FIG. 1, and further includes categories that are selected less frequently but are still a valid category since number stencils can also be categorized as “Craft Supplies” under the broader “Paint” category.

Yet, simply considering the presence of multiple labels may not be sufficient to correctly represent a query classification prediction model. For example, a skewed prediction can be produced when a given query that has an interaction of 1% with a first label and 99% with a second label is considered in the same way another query that has 99% interaction with the first label and 1% interaction with the second label. Such a prediction can be skewed because the minority label can take precedence on the more popular usage of the query. This can be impactful when the predicted query labels are used as input features to optimize (or re-rank) a search result returning matching products from a catalog. Considering the first example in FIG. 2, a search engine can return a majority of products from the “Craft Supplies” minority class rather than boosting results from the “Stencils” category compromising the result relevance.

Besides query classification in the e-commerce domain, there are other domains with similar challenges. For example, movies can have more than one genre label and each label can also contribute with different weights to the overall movie genre. “The Lord of the Rings” movie, for instance, can be considered an adventure, drama, and fantasy at the same time with each label weighted differently. Negative online behaviors classification, which has been recently getting the attention to improve online conversations and content, can also be considered a multi-label problem since toxic comments can have different labels at the same time (e.g., severe_toxic, obscene, threat, insult, identity_hate). One difference with the e-commerce domain is that e-commerce is also considered an extreme classification task due to the number of labels that often reach several thousand labels.

Accordingly, some implementations of the current subject matter include formulating the problem of query label classification in a particular multi-class classification setting, where the target label of a given example X is not a single label (as typically represented in a multi-class classification problem with one-hot encoding (e.g., only one label at a time is allowed)), but as a distribution over multiple relevant labels. Since, in some implementations, the annotation of the data comes from behavioral signals, queries can be automatically assigned to multiple labels each with a certain distribution that does not extend to the full set of labels. Rather queries can be assigned to multiple labels concentrated to a small number of relevant labels (e.g., soft-labels with a sparse representation). Using a weighted sparse label representation provides a more accurate prediction and improved query category classification.

To train a classification model that can predict these types of weighted sparse label representations, two tasks can be addressed: 1) data preprocessing, pruning, and partitioning that preserves the multi-label distributions; and 2) provide an example machine learning method that predicts multiple sparse (e.g., a small percentage of the label space for each prediction) labels accordingly to the labels distributions and weights.

Regarding preprocessing, product search queries typically include several extraneous characters and information that is not useful for classification. To reduce data noise and space dimensionality, it can be useful to apply preprocessing and normalization steps to the data. Example preprocessing and/or normalization steps include: measurements normalization (e.g., 1″ expands to 1 inch); punctuation normalization and removal; non-ASCII characters removal; tokens with mixed numbers and characters replacement (e.g., asjhd345sh replaced with abc123 as a placeholder for this type of token); tokens with numbers only replacement (non-measurements); and lower-casing. An example of preprocessing can include taking an input text:
2×4 “3” cu ft 6063-t5 alloy 938573
   And determining a preprocessed and normalized text:
2×4 3 cubic foot <alpha> alloy <num>

Label pruning can reduce data sparsity. To reduce data sparsity for the category labels associated with less frequent clicks, a large catalog taxonomy tree can be pruned to increase the density of less frequent queries. Labels with less than N-tagged examples (e.g., N=50) can be merged with the upper taxonomy node and their labels can be replaced with the upper-level taxonomy label. An example of label pruning is illustrated in FIG. 3. An example taxonomy 300 is illustrated as a tree-structure, where nodes form categories, and label occurrence count is illustrated below several leaf nodes. In the example where labels with less than k-tagged (N=50) are merged with the upper taxonomy node, the label “cycling gloves” (count of 34) is merged with node “cycling”. Similarly, “heavy metal” is merged with “music.” For each label in the taxonomy tree, the number of examples per node can be tracked to capture the real distribution. In some implementations, after applying the pruning procedure, every leaf in the taxonomy tree can include at least N samples.

After preprocessing and pruning, the data can be split into training, development, and test folds using a K-fold stratified partitioning procedure for multi-label data, where K is the number of data split used in the modeling process (e.g., if K=3, there can be a training set, a development set, and a test set). An example approach is described in Konstantinos Sechidis, Grigorios Tsoumakas, and Ioannis Vlahavas. 2011. On the stratification of multi-label data. In Proceedings of the 2011 European conference on Machine learning and knowledge discovery in databases—Volume Part III (ECML PKDD'11). Springer-Verlag, Berlin, Heidelberg, 145-158. In an example, the number of folds can be, for instance, three with a large training set (90%) and two smaller testing (5%) and development sets (5%).

The iterative stratified splitting procedure described in Sechidis, et al. (2011) can be adapted to accommodate frequency-weighted samples. Query weights can be derived by the frequency of the clicks associated with the selected product category. For instance, in FIG. 2, the query “number stencils for painting” generated significant clicks for 28 products in the category Hardware and 3 products in the category Paint. In that case, a weight of 0.90 can be associated with the label Hardware and 0.10 with the label Paint. Some implementations of the current subject matter can allow for using weights instead of raw query counts for computing the fold label requirements. Since a query can have multiple labels, each label can be multiplied by the query weight and added to the total label count. During the data splitting, the query weights can be deducted from the fold label requirement values. This approach can ensure that the queries with greater weight are distributed first, thus the distribution of head/torso/tail queries can be maintained across the folds.

As a result, the data can be split such that the data split maintains the folds as disjoint in terms of samples and maintains the same label distribution. In general, using random sampling processes to split data folds can produce partitions with missing labels where classes are not sufficiently represented in the data.

To predict a distribution over the labels for each input query, a classifier can be trained on the collected and preprocessed data from the user clickstream data (e.g., input query and whether the user selected a product and/or category). In some implementations, a pre-trained general-purpose language representation model that includes unsupervised natural language data to represent words and context semantic can be used. An example pre-trained general-purpose language representation model includes DistilBERT (Victor Sanh, Lysandre Debut, Julien Chaumond, and Thomas Wolf. DistilBERT, a distilled version of BERT: smaller, faster, cheaper and lighter. arXiv preprint arXiv:1910.01108, 2019). The language representation model can take a sequence of word and, by leveraging a self-attention mechanism, produce a contextualized representation for each word in the sequence. An example self-attention mechanism is described by Ashish Vaswani, Noam Shazeer, Niki Parmar, Jakob Uszkoreit, Llion Jones, Aidan N Gomez, Lukasz Kaiser, and Illia Polosukhin. 2017. Attention is all you need. In NIPS. 5998-6008. In some implementations, before inputting to the model each sequence can be prepended with a special token (CLS) whose contextualized representation can be used for classifying the whole sequence. Another special token (SEP) can be appended to the sequence to show end of the sequence. In some implementations, for query classification, the CLS token representation of queries can be used as input to a two-layer feed-forward neural network with Exponential Linear Unit (ELU) nonlinear function in between layers to classify the query into labels.

To train the model, a sparsity layer (e.g., a Sparsemax layer) can be used to generate a sparse probability distribution over the labels. (Martins, André F. T. and Ramon Fernandez Astudillo. “From Softmax to Sparsemax: A Sparse Model of Attention and Multi-Label Classification.” ICML (2016)). In some implementations, using Sparsemax instead of a Softmax layer can be beneficial since Sparsemax generates a sparse output, which is in line with the query classification problem where most of the classes are irrelevant to the input query and have zero probability. Then, a cross-entropy loss can be computed between the output of the Sparsemax layer and the target distribution to update the model's weight using gradient back-propagation. In some implementations, for training the model, an Adam optimizer with learning rate 0.00003 can be used to train the model with considering the first 3 epochs as warmup steps, and the training is continued until completing 10 epochs. An example Adam optimizer is described in Diederik P. Kingma and Jimmy Lei Ba. Adam: A method for stochastic optimization. 2014. arXiv:1412.6980v9.

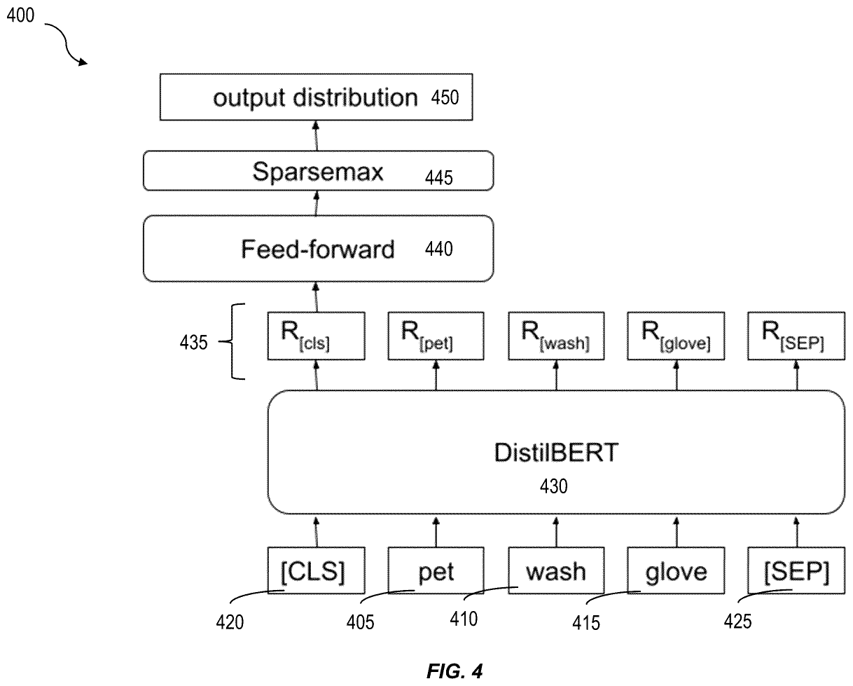

FIG. 4 is an example data flow diagram 400 for determining output distribution from search queries. An input query sequence including three words “pet” 405, “wash” 410, “glove” 415 is tokenized by prepending the input query sequence with a token CLS 420 and appended with another token SEP 425. The tokenized input query sequence is input into a pre-trained general-purpose language representation model 430 (e.g., DistilBERT), which outputs the CLS token representation of the query 435. The CLS token representation of the query 435 can be input into a feed-forward neural network 440 to classify the query into labels. The determined labels are input into a Sparsemax layer 445, which outputs the distribution representation 450 of the multiple labels for the query.

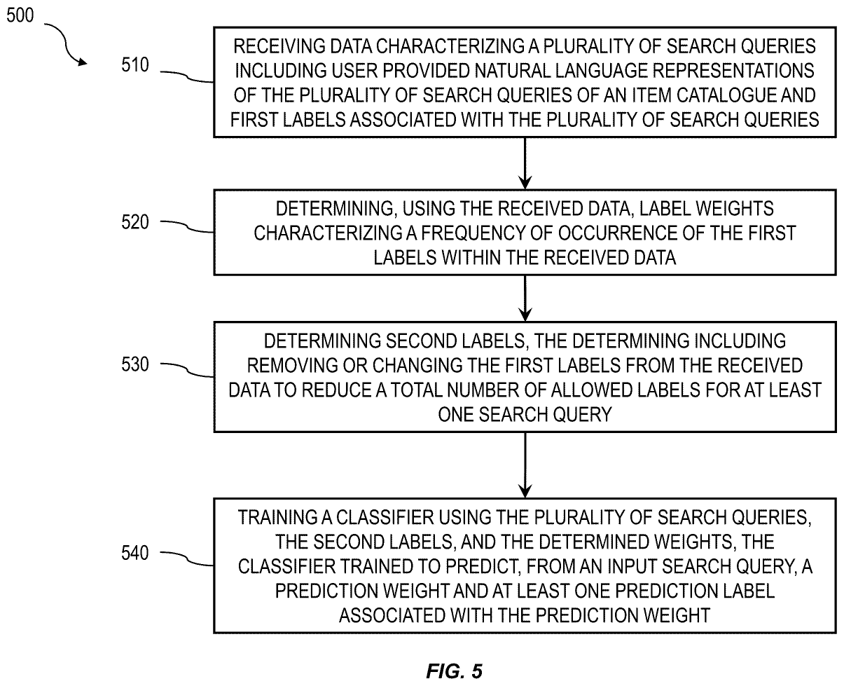

FIG. 5 is a process flow diagram illustrating an example process 500 of training a query classifier that utilizes sparse soft labels and can improve query label prediction. At 510, data is received characterizing a plurality of search queries including user provided natural language representations of the search queries of an item catalogue and first labels associated with the plurality of search queries. For example, the plurality of search queries can include natural language representations of the queries illustrated and described in FIGS. 1 and 2 (e.g., “number stencils for painting”, “garden hose connector”, “pet wash glove”, and the like).

The received first labels can be categories of items in the item catalogue, which can be considered as a hierarchical taxonomy (e.g., having categories and sub-categories organized in a tree or tree-like structure). For example, the first labels can include the labels as described in FIGS. 1 and 2 (e.g., “hardware/signs, letters & numbers/stencils” corresponding to query “number stencils for painting”). Each query can have one or more associated labels. The query to label pairings can have been determined by user behavior data (e.g., clickstream data characterizing user input query) and subsequent action (e.g., selecting product, adding to card, abandoning search or site, and the like). In some implementations, an occurrence frequency of a query and label pair can be determined.

At 520, label weights characterizing a frequency of occurrence of the labels within the received data can be determined using the received data. Query weight can be derived by the frequency of the search query to label pairings (e.g., clicks associated with the selected product category characterizing user input). The number of clicks associated with the selected product category can be taken into consideration for the query label weight (e.g., a measure of importance). For example, in FIG. 2, the query “number stencils for painting” generated significant clicks for 28 products in the category “Hardware” and 3 products in the category “Paint.” In that case, a weight of 0.90 can be associated with the label “Hardware” and 0.10 with the label “Paint.” Because some implementations of the current subject matter utilizes weights instead of raw query counts for computing the fold label requirements, improved prediction can be achieved.

At 530, second labels can be determined. The determining can include removing or changing the first labels from the received data to limit a total number of allowed labels. For example, the categories in the catalogue can be pruned to limit a number of allowed labels. The pruning can be based on a count of the labels occurring within the received data, for example, as described above with reference to FIG. 3.

In some implementations, determining the second labels can include applying a sparsity constraint to the first labels. For example, applying a sparsity constraint can include applying Sparsemax. In some implementations, applying the sparsity constraint to the first labels includes computing a metric and removing or changing labels within the first labels that satisfy the metric. In some implementations, the second labels are represented as a sparse array. The second labels can be a subset of the first labels.

In some implementations, the determining the second labels can include determining a probability distribution of the second labels for each search query, where the probability distribution is associated with or includes the determined weights.

In some implementations, the received data can be split into at least a training set, a development set, and a test set. During data splitting, query weights can be deducted from fold label requirement values, which can ensure that the queries weighted more are distributed first, thus the distribution of head/torso/tail queries is maintained across the folds. As result, splitting can occur such that folds are kept disjoint in terms of samples, maintaining the same label distribution.

At 540, a classifier can be trained using the plurality of search queries, the second labels, and the determined weights. The classifier can be trained to predict, from an input search query, a prediction weight and a prediction label.

In some implementations, training the classifier includes using the probability distribution. Training the classifier can include determining, using a natural language model, contextualized representations for words in the natural language representation, tokenizing the contextualized representations, and wherein the training the classifier is performed using the tokenized contextual representations. The tokenized contextual representations are input to a multilayer feed forward neural network with a nonlinear function in between at least two layers of the multilayer feed forward neural network.

In some implementations, the training can further include determining a cost of error measured based on a distance between labels within a hierarchical taxonomy. For example, a cost of an incorrect prediction can be measured as a distance within the hierarchical taxonomy (e.g., tree structure of labels) between the correct label and the incorrectly predicted label.

In some implementations, query classification can be applied directly to search engines to produce more relevant results. For example, the trained classifier can be used to answer a search query. For example, a query can be received characterizing a user provided natural language representation of a search query of a catalog of items. A second prediction weight, and a second prediction label can be determined using the trained classifier. For example, in some implementations, multiple labels can be predicted with associated confidence scores. The prediction label with the highest confidence score based on the classification model can be selected (e.g., as the second prediction label). The selected prediction label can be provided to a query engine (e.g., search engine) for execution of the query. By improving the prediction of the label, query results of the query engine can be improved (e.g., by giving the query engine additional information regarding the label, query results can be improved).

The query can be executed on the catalogue and using the second prediction weight and the second prediction label. Results of the query execution can be provided, for example, to the user.

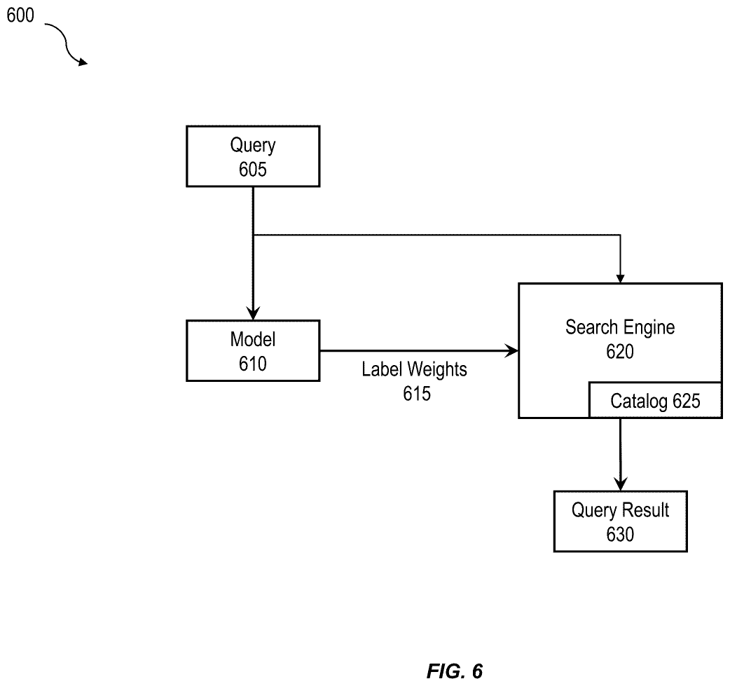

In some implementations, the current subject matter can be applied to an ecommerce search engine to increase the relevance of the results. For example, a query like “Show me 5 star rated Candles above $50” may confuse a traditional search engine but predicting categories such as ‘Home Decor/Home Accents’ with high confidence and ‘Holiday Decorations/Christmas Decorations’ with lower confidence score will help to optimize and balance the search results to increase the results relevance. FIG. 6 is a system block diagram illustrating an example ecommerce search system 600 according to some examples of the current subject matter. A query 605 can be received and provided to a model 610 trained according to, for example, the process described above with respect to FIG. 5. The model 610 can predict, using the query 605, label weights 615. Using the label weights 615 and the query 605, a search engine 620 can search a catalog 625 for a relevant result. The search engine 620 can provide a query result 630.

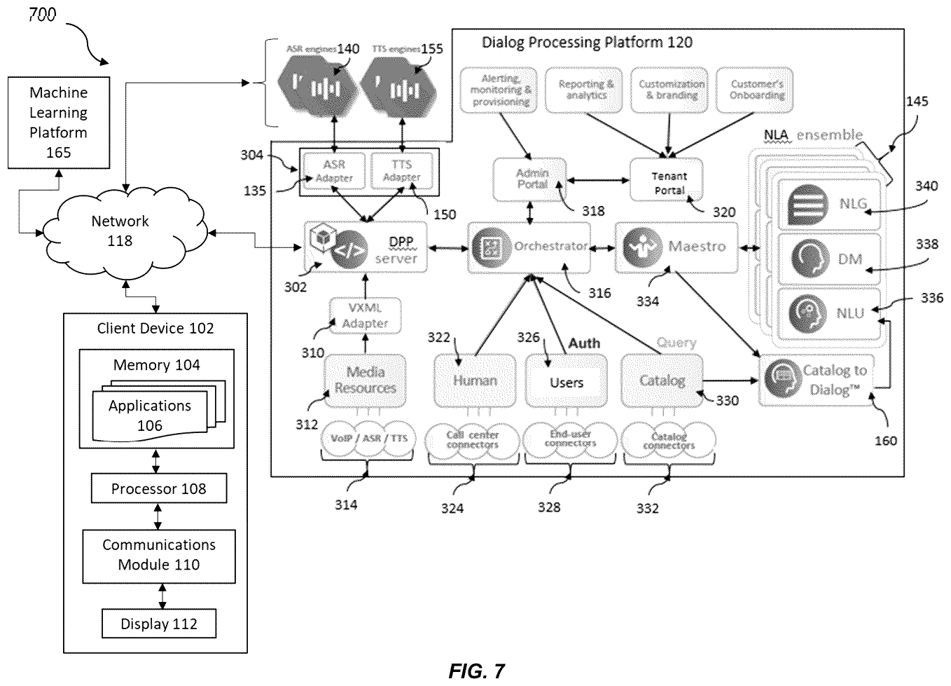

FIG. 7 illustrates an example conversational system 700 that can utilize a classifier trained according to some implementations of the current subject matter to perform queries of an item catalogue. The conversational system 700 can include a client device 102, a dialog processing platform 120, and a machine learning platform 165. The client device 102, the dialog processing platform 120, and the machine learning platform 165 can be communicatively coupled via a network, such as network 118. In broad terms, a user can provide a query input including one or more expressions to the client device 102. The client device 102 can include a frontend of the conversational system 700. A conversational agent can be configured on the client device 102 as one or more applications 106. The conversational agent can transmit data associated with the query to a backend of the conversational system 700. The dialog processing platform 120 can be configured as the backend of the conversational system 700 and can receive the data from the client device 102 via the network 118. The dialog processing platform 120 can process the transmitted data to generate a response to the user query, such as an item name, and can provide the generated response to the client device 102. The client device 102 can then output the query response. A user may iteratively provide inputs and receive outputs via the conversational system 100 in a dialog. The dialog can include natural language units, such as words, which can be processed and generated in the context of a lexicon that is associated with the domain for which the conversational system 700 has been implemented. In some implementations, the conversational system 700 can support multiple tenants and/or entities.

As shown in FIG. 7, the conversational system 700 includes a client device 102. The client device 102 can include a large-format computing device or any other fully functional computing device, such as a desktop computers or laptop computers, which can transmit user data to the dialog processing platform 120. Additionally, or alternatively, other computing devices, such as a small-format computing devices 102 can also transmit user data to the dialog processing platform 120. Small-format computing devices 102 can include a tablet, smartphone, intelligent or virtual digital assistant, or any other computing device configured to receive user inputs as voice and/or textual inputs and provide responses to the user as voice and/or textual outputs.

The client device 102 includes a memory 104, a processor 108, a communications module 110, and a display 112. The memory 104 can store computer-readable instructions and/or data associated with processing multi-modal user data via a frontend and backend of the conversational system 700. For example, the memory 104 can include one or more applications 106 implementing a conversational agent application. The applications 106 can provide speech and textual conversational agent modalities to the client device 102 thereby configuring the client device 102 as a digital or telephony endpoint device. The processor 108 operates to execute the computer-readable instructions and/or data stored in memory 104 and to transmit the computer-readable instructions and/or data via the communications module 110. The communications module 110 transmits the computer-readable instructions and/or user data stored on or received by the client device 102 via network 118. The network 118 connects the client device 102 to the dialog processing platform 120. The network 118 can also be configured to connect the machine learning platform 165 to the dialog processing platform 120. The network 118 can include, for example, any one or more of a personal area network (PAN), a local area network (LAN), a campus area network (CAN), a metropolitan area network (MAN), a wide area network (WAN), a broadband network (BBN), the Internet, and the like. Further, the network 118 can include, but is not limited to, any one or more of the following network topologies, including a bus network, a star network, a ring network, a mesh network, a star-bus network, tree or hierarchical network, and the like. The client device 102 also includes a display 112. In some implementations, the display 112 can be configured within or on the client device 102. In other implementations, the display 112 can be external to the client device 102. The client device 102 can also include an input device, such as a microphone to receive voice inputs, or a keyboard, to receive textual inputs. The client device 102 can also include an output device, such as a speaker or a display.

The client device 102 can include a conversational agent frontend, e.g., one or more of applications 106, which can receive inputs associated with a user query and to provide responses to the users query. For example, the client device 102 can receive user queries which are uttered, spoken, or otherwise verbalized and received by an input device, such as a microphone. In some implementations, the input device can be a keyboard and the user can provide query data as a textual input, in addition to or separately from the inputs provided using a voice-based modality. The applications 106 can include easily installed, pre-packaged software developer kits for which implement conversational agent frontend functionality on a client device 102. The applications 106 can include APIs as JavaScript libraries received from the dialog processing platform 120 and incorporated into a website of the entity or tenant to enable support for text and/or voice modalities via a customizable user interfaces. The applications 106 can implement client APIs on different client devices 102 and web browsers in order to provide responsive multi-modal interactive user interfaces that are customized for the entity or tenant. The GUI and applications 106 can be provided based on a profile associated with the tenant or entity. In this way, the conversational system 700 can provide customizable branded assets defining the look and feel of a user interface, different voices utilized by the text-to-speech synthesis engines 140, as well as textual responses generated by the NLA ensembles 145, which are specific to the tenant or entity.

As shown in FIG. 7, the conversational system 700 also includes a dialog processing platform 120. The dialog processing platform 120 operates to receive dialog data, such as user queries provided to the client device 102, and to process the dialog data to generate responses to the user provided dialog data. The dialog processing platform 120 can be configured on any device having an appropriate processor, memory, and communications capability for hosting the dialog processing platform as will be described herein. In certain aspects, the dialog processing platform can be configured as one or more servers, which can be located on-premises of an entity deploying the conversational system 700, or can be located remotely from the entity. In some implementations, the distributed processing platform 120 can be implemented as a distributed architecture or a cloud computing architecture. In some implementations, one or more of the components or functionality included in the dialog processing platform 120 can be configured in a microservices architecture, for example in a cloud computing environment. In this way, the conversational system 700 can be configured as a robustly scalable architecture that can be provisioned based on resource allocation demands. In some implementations, one or more components of the dialog processing platform 120 can be provided via a cloud computing server of an infrastructure-as-a-service (IaaS) and be able to support a platform-as-a-service (PaaS) and software-as-a-service (SaaS) services.

The dialog processing platform 120 can also include a communications module to receive the computer-readable instructions and/or user data transmitted via network 118. The dialog processing platform 120 also can also include one or more processors configured to execute instructions that when executed cause the processors to perform natural language processing on the received dialog data and to generate contextually specific responses to the user dialog inputs using one or more interchangeable and configurable natural language processing resources. The dialog processing platform 120 can also include a memory configured to store the computer-readable instructions and/or user data associated with processing user dialog data and generating dialog responses. The memory can store a plurality of profiles associated with each tenant or entity. The profile can configure one or more processing components of the dialog processing platform 120 with respect to the entity or tenant for which the conversational system 700 has been configured.

The dialog processing platform 120 can serve as a backend of the conversational system 700. One or more components included in the dialog processing platform 120 shown in FIG. 7 can be configured on a single server device or on multiple server devices. One or more of the components of the dialog processing platform 120 can also be configured as a microservice, for example in a cloud computing environment. In this way, the conversational system 700 can be configured as a robustly scalable architecture that can be provisioned based on resource allocation demands.

The dialog processing platform 120 includes run-time components that are responsible for processing incoming speech or text inputs, determining the meaning in the context of a dialog and a tenant lexicon, and generate replies to the user which are provided as speech and/or text. Additionally, the dialog processing platform 120 provides a multi-tenant portal where both administrators and tenants can customize, manage, and monitor platform resources, and can generate run-time reports and analytic data. The dialog processing platform 120 interfaces with a number of natural language processing resources such as automated speech recognition (ASR) engines 140, text-to-speech (TTS) synthesis engines 155, and various telephony platforms.

For example, as shown in FIG. 7, the dialog processing platform 120 includes a plurality of adapters 304 configured interface the ASR engines 140 and the TTS synthesis engines 155 to the DPP server 302. The adapters 304 allow the dialog processing platform 120 to interface with a variety of real-time speech processing engines, such as ASR engines 140 and TTS synthesis engines 155. The ASR engine adapter 135 and a TTS synthesis engine adapter 150 enable tenants to dynamically select speech recognition and text-to-speech synthesis providers or natural language speech processing resources that best suit the users objective, task, dialog, or query. In some implementations, the ASR engines 140 and the TTS synthesis engines 155 can be configured in a cloud-based architecture of the dialog processing platform 120 and may not be collocated in the same server device as the DPP server 302 or other components of the dialog processing platform 120.

The ASR engines 140 can include automated speech recognition engines configured to receive spoken or textual natural language inputs and to generate textual outputs corresponding the inputs. For example, the ASR engines 140 can process the user's verbalized query or utterance “I'd like a garden hose connector” into a text string of natural language units characterizing the query. The text string can be further processed to determine an appropriate query response. The dialog processing platform 120 can dynamically select a particular ASR engine 140 that best suits a particular task, dialog, or received user query.

The TTS synthesis engines 155 can include text-to-speech synthesis engines configured to convert textual responses to verbalized query responses. In this way, a response to a user's query can be determined as a text string and the text string can be provided to the TTS synthesis engines 155 to generate the query response as natural language speech. The dialog processing platform 120 can dynamically select a particular TTS synthesis engine 155 that best suits a particular task, dialog, or generated textual response.

As shown in FIG. 7, the dialog processing platform 120 includes a DPP server 302. The DPP server 302 can act as a frontend to the dialog processing platform 120 and can appropriately route data received from or to be transmitted to client devices 102 as appropriate. The DPP server 302 routes requests or data to specific components of the dialog processing platform 120 based on registered tenant and application identifiers which can be included in a profile associated with a particular tenant. The DPP server 302 can also securely stream to the ASR engines 140 and from the TTS synthesis engines 140.

As shown in FIG. 7, the dialog processing platform 120 includes at least one adapter 310 (e.g., for telephony such as voiceXML (VXML), messaging, chat bot, and the like), which can couple the DPP server 302 to various media resources 312. For example, the media resources 312 can include VoIP networks, ASR engines, and TTS synthesis engines 314. In some implementations, the media resources 312 enable the conversational agents to leverage existing telephony platforms, which can often be integrated with particular speech processing resources. The existing telephony platforms can provide interfaces for communications with VOIP infrastructures using session initiation protocol (SIP). In these configurations, VXML documents are exchanged during a voice call.

The dialog processing platform 120 also includes an orchestrator component 316. The orchestrator 316 provides an interface for administrators and tenants to access and configure the conversational system 700. The administrator portal 318 can enable monitoring and resource provisioning, as well as providing rule-based alert and notification generation. The tenant portal 320 can allow customers or tenants of the conversational system 700 to configure reporting and analytic data, such as account management, customized reports and graphical data analysis, trend aggregation and analysis, as well as drill-down data associated dialog utterances. The tenant portal 320 can also allow tenants to configure branding themes and implement a common look and feel for the tenant's conversational agent user interfaces. The tenant portal 320 can also provide an interface for onboarding or bootstrapping customer data. In some implementations, the tenant portal 320 can provide tenants with access to customizable conversational agent features such as user prompts, dialog content, colors, themes, usability or design attributes, icons, and default modalities, e.g., using voice or text as a first modality in a dialog. The tenant portal 320 can, in some implementations, provide tenants with customizable content via different ASR engines 140 and different TTS synthesis engines 155, which can be utilized to provide speech data in different voices and/or dialects. In some implementations, the tenant portal 320 can provide access to analytics reports and extract, transform, load (ETL) data feeds.

The orchestrator 316 can provide secure access to one or more backends of a tenant's data infrastructure. The orchestrator 316 can provide one or more common APIs to various tenant data sources, which can be associated with retail catalog data, user accounts, order status, order history, and the like. The common APIs can enable developers to reuse APIs from various client side implementations.

The orchestrator 316 can further provide an interface 322 to human resources, such as human customer support operators who may be located at one or more call centers. The dialog processing platform 120 can include a variety of call center connectors 324 configured to interface with data systems at one or more call centers.

The orchestrator 316 can also provide an interface 326 configured to retrieve authentication information and propagate user authentication and/or credential information to one or more components of the system 700 to enable access to a user's account. For example, the authentication information can identify one or more users, such as individuals who have accessed a tenant web site as a customer or who have interacted with the conversational system 700 previously. The interface 326 can provide an authentication mechanism for tenants seeking to authenticate users of the conversational system 700. The dialog processing platform 120 can include a variety of end-user connectors 328 configured to interface the dialog processing platform 120 to one or more databases or data sources identifying end-users.

The orchestrator 316 can also provide an interface 330 to tenant catalog and e-commerce data sources. The interface 330 can enable access to the tenant's catalog data which can be accessed via one or more catalog or e-commerce connectors 332. The interface 330 enables access to tenant catalogs and/or catalog data and further enables the catalog data to be made available to the CTD modules 160. In this way, data from one or more sources of catalog data can be ingested into the CTD modules 160 to populate the modules with product or item names, descriptions, brands, images, colors, swatches, as well as structured and free form item or product attributes. The interface 326 can also enable access to the tenant's customer order and billing data via one or more catalog or e-commerce connectors 328.

The dialog processing platform 120 also includes a maestro component 334. The maestro 334 enables administrators of the conversational system 700 to manage, deploy, and monitor conversational agent applications 106 independently. The maestro 334 provides infrastructure services to dynamically scale the number of instances of natural language resources, ASR engines 140, TTS synthesis engines 155, NLA ensembles 145, and CTD modules 160. The maestro 334 can dynamically scale these resources as dialog traffic increases. The maestro 334 can deploy new resources without interrupting the processing being performed by existing resources. The maestro 334 can also manage updates to the CTD modules 160 with respect to updates to the tenants e-commerce data and/or product catalogs. In this way, the maestro 334 provided the benefit of enabling the dialog processing platform 120 to operate as a highly scalable infrastructure for deploying artificially intelligent multi-modal conversational agent applications 106 for multiple tenants. As a result, the conversational system 700 can reduce the time, effort, and resources required to develop, test, and deploy conversational agents.

As shown in FIG. 7, the maestro 334 can interface with a plurality of natural language agent (NLA) ensembles 145. The NLA ensembles 145 can include a plurality of components configured to receive the text string from the ASR engines 140 and to process the text string in order to determine a textual response to the user query. The NLA ensembles 145 can include a natural language understanding (NLU) module implementing a number of classification algorithms trained in a machine learning process to classify the text string into a semantic interpretation. The processing can include classifying an intent of the text string and extracting information from the text string. The NLU module combines different classification algorithms and/or models to generate accurate and robust interpretation of the text string. The NLA ensembles 145 can also include a dialog manager (DM) module. The DM module can determine an appropriate dialog action in a contextual sequence formed by the current or previous dialog sequences conducted with the user. In this way, the DM can generate a response action to increase natural language quality and fulfillment of the user's query objective. The NLA ensembles 145 can also include a natural language generator (NLG) module. The NLG module can process the action response determined by the dialog manager and can convert the action response into a corresponding textual response. The NLG module provides multimodal support for generating textual responses for a variety of different output device modalities, such as voice outputs or visually displayed (e.g., textual) outputs.

Each of the NLA ensembles 145 can include one or more of a natural language generator (NLG) module 336, a dialog manager (DM) module 338, and a natural language understanding (NLU) module 340. In some implementations, the NLA ensembles 145 can include pre-built automations, which when executed at run-time, implement dialog policies for a particular dialog context. For example, the pre-built automations can include dialog policies associated with searching, frequently-asked-questions (FAQ), customer care or support, order tracking, and small talk or commonly occurring dialog sequences which may or may not be contextually relevant to the user's query. The NLA ensembles 145 can include reusable dialog policies, dialog state tracking mechanisms, domain and schema definitions. Customized NLA ensembles 145 can be added to the plurality of NLA ensembles 145 in a compositional manner as well.

As shown in FIG. 7, the NLA ensemble 145 includes a natural language understanding (NLU) module 336. The NLU module 336 can implement a variety of classification algorithms used to classify input text associated with a user query and generated by the ASR engines 140 into a semantic interpretation. In some implementations, the NLU module 336 can implement a stochastic intent classifier and a named-entity recognizer ensemble to perform intent classification and information extraction, such as extraction of entity or user data. The NLU module 336 can combine different classification algorithms and can select the classification algorithm most likely to provide the best semantic interpretation for a particular task or user query by determining dialog context and integrating dialog histories.

The classification algorithms included in the NLU module 336 can be trained in a supervised machine learning process using support vector machines or using conditional random field modeling methods. In some implementations, the classification algorithms included in the NLU module 336 can be trained using a convolutional neural network, a long short-term memory recurrent neural network, as well as a bidirectional long short-term memory recurrent neural network. The NLU module 336 can receive the user query and can determine surface features and feature engineering, distributional semantic attributes, and joint optimizations of intent classifications and entity determinations, as well as rule based domain knowledge in order to generate a semantic interpretation of the user query. In some implementations, the NLU module 336 can include one or more of intent classifiers (IC), named entity recognition (NER), and a model-selection component that can evaluate performance of various IC and NER components in order to select the configuration most likely generate contextually accurate conversational results. The NLU module 336 can include competing models which can predict the same labels but using different algorithms and domain models where each model produces different labels (customer care inquires, search queries, FAQ, etc.).

The NLA ensemble 145 also includes a dialog manager (DM) module 338. The DM module 338 can select a next action to take in a dialog with a user. The DM module 338 can provided automated learning from user dialog and interaction data. The DM module 338 can implement rules, frames, and stochastic-based policy optimization with dialog state tracking. The DM module 338 can maintain an understanding of dialog context with the user and can generate more natural interactions in a dialog by providing full context interpretation of a particular dialog with anaphora resolution and semantic slot dependencies. In new dialog scenarios, the DM module 338 can mitigate “cold-start” issues by implementing rule-based dialog management in combination with user simulation and reinforcement learning. In some implementations, sub-dialog and/or conversation automations can be reused in different domains.

The DM module 338 can receive semantic interpretations generated by the NLU module 336 and can generate a dialog response action using context interpreter, a dialog state tracker, a database of dialog history, and an ensemble of dialog action policies. The ensemble of dialog action policies can be refined and optimized using rules, frames and one or more machine learning techniques.

As further shown in FIG. 7, the NLA ensemble 145 includes a natural language generator (NLG) module 340. The NLG module 340 can generate a textual response based on the response action generated by the DM module 338. For example, the NLG module 340 can convert response actions into natural language and multi-modal responses that can be uttered or spoken to the user and/or can be provided as textual outputs for display to the user. The NLG module 340 can include a customizable template programming language which can be integrated with a dialog state at runtime.

In some implementations, the NLG module 340 can be configured with a flexible template interpreter with dialog content access. For example, the flexible template interpreter can be implemented using Jinja2, a web template engine. The NLG module 340 can receive a response action the DM module 338 and can process the response action with dialog state information and using the template interpreter to generate output formats in speech synthesis markup language (SSML), VXML, as well as one or more media widgets. The NLG module 340 can further receive dialog prompt templates and multi-modal directives. In some implementations, the NLG module 340 can maintain or receive access to the current dialog state, a dialog history, and can refer to variables or language elements previously referred to in a dialog. For example, a user may have previously provided the utterance “I am looking for a pair of shoes for my wife”. The NLG module 340 can label a portion of the dialog as PERSON_TYPE and can associate a normalized GENDER slot value as FEMALE. The NLG module 340 can inspect the gender reference and customize the output by using the proper gender pronouns such as ‘her, she, etc.’

The dialog processing platform 120 also includes catalog-to-dialog (CTD) modules 160. The CTD modules 160 can be selected for use based on a profile associated with the tenant or entity. The CTD modules 160 can automatically convert data from a tenant or entity catalog, as well as billing and order information into a data structure corresponding to a particular tenant or entity for which the conversational system 700 is deployed. The CTD modules 160 can derive product synonyms, attributes, and natural language queries from product titles and descriptions, which can be found in the tenant or entity catalog. The CTD modules 160 can generate a data structure that is used by the machine learning platform 165 to train one or more classification algorithms included in the NLU module 336. For example, training, such as described above with respect to FIG. 4-5 can be performed to generate a predictive model for use in executing the user query of the item catalogue. As noted above, the query classifier can form part of the NLU module 336, which can decide to utilize the query classifier in the case the user input is classified as a search query. If not, the NLU module 336 will apply other models (e.g., classification). The query classifier can also be used independently to provides its output to the search engine and recalibrate relevance. In some implementations, the CTD modules 160 can be used to efficiently pre-configure the conversational system 700 to automatically respond to queries about orders and/or products or services provided by the tenant or entity. For example, the dialog processing platform 120 can process the users query to determine a response regarding the previously placed order. As a result of the processing, the dialog processing platform 120 can generate a response to the user's query. The query response can be transmitted to the client device 102 and provided as speech output via an output device and/or provided as text displayed via display 112.

The CTD module 160 can implement methods to collect e-commerce data from tenant catalogs, product reviews, and user clickstream data collected at the tenants web site to generate a data structure that can be used to learn specific domain knowledge and to onboard or bootstrap a newly configured conversational system 700. The CTD module 160 can extract taxonomy labels associated with hierarchical relationships between categories of products and can associate the taxonomy labels with the products in the tenant catalog. The CTD module 160 can also extract structured product attributes (e.g., categories, colors, sizes, prices) and unstructured product attributes (e.g., fit details, product care instructions) and the corresponding values of those attributes. The CTD module 160 can normalize attribute vales so that the attribute values share the same format throughout the catalog data structure. In this way, noisy values caused by poorly formatted content can be removed.

As described above with reference to FIG. 3, products in an e-commerce catalogs can be typically organized in a multi-level taxonomy, which can group the products into specific categories. The categories can be broader at higher levels (e.g., there are more products) and narrower (e.g., there are less products) at lower levels of the product taxonomy. For example, a product taxonomy associated with clothing can be represented as Clothing>Sweaters>Cardigans & Jackets. The category “Clothing” is quite general, while “Cardigans & Jackets” are a very specific type of clothing. A user's queries can refer to a category (e.g., dresses, pants, skirts, etc.) identified by a taxonomy label or to a specific product item (e.g., item #30018, Boyfriend Cardigan, etc.). In a web-based search session, a product search could either start from a generic category and narrow down to a specific product or vice versa. CTD module 160 can extract category labels from the catalog taxonomy, product attributes types and values, as well as product titles and descriptions.

The CTD module 160 can automatically generate attribute type synonyms and lexical variations for each attribute type from search query logs, product descriptions and product reviews and can automatically extract referring expressions from the tenant product catalog or the user clickstream data. The CTD module 160 can also automatically generate dialogs based on the tenant catalog and the lexicon of natural language units or words that are associated with the tenant and included in the data structure.

The CTD module 160 utilizes the extracted data to train classification algorithms to automatically categorize catalog categories and product attributes when provided in a natural language query by a user. The extracted data can also be used to train a full search engine based on the extracted catalog information. The full search engine can thus include indexes for each product category and attribute. The extracted data can also be used to automatically define a dialog frame structure that will be used by a dialog manger module, described later, to maintain a contextual state of the dialog with the user.

The conversational system 700 includes a machine learning platform 165. Machine learning can refer to an application of artificial intelligence that automates the development of an analytical model by using algorithms that iteratively learn patterns from data without explicit indication of the data patterns. Machine learning can be used in pattern recognition, computer vision, email filtering and optical character recognition and enables the construction of algorithms or models that can accurately learn from data to predict outputs thereby making data-driven predictions or decisions.

The machine learning platform 165 can include a number of components configured to generate one or more trained prediction models suitable for use in the conversational system. For example, during a machine learning process, a feature selector can provide a selected subset of features to a model trainer as inputs to a machine learning algorithm to generate one or more training models. A wide variety of machine learning algorithms can be selected for use including algorithms such as support vector regression, ordinary least squares regression (OLSR), linear regression, logistic regression, stepwise regression, multivariate adaptive regression splines (MARS), locally estimated scatterplot smoothing (LOESS), ordinal regression, Poisson regression, fast forest quantile regression, Bayesian linear regression, neural network regression, decision forest regression, boosted decision tree regression, artificial neural networks (ANN), Bayesian statistics, case-based reasoning, Gaussian process regression, inductive logic programming, learning automata, learning vector quantization, informal fuzzy networks, conditional random fields, genetic algorithms (GA), Information Theory, support vector machine (SVM), Averaged One-Dependence Estimators (AODE), Group method of data handling (GMDH), instance-based learning, lazy learning, and Maximum Information Spanning Trees (MIST).

The CTD modules 160 can be used in the machine learning process to train the classification algorithms included in the NLU of the NLA ensembles 145. The model trainer can evaluate the machine learning algorithm's prediction performance based on patterns in the received subset of features processed as training inputs and generates one or more new training models. The generated training models, e.g., classification algorithms and models included in the NLU of the NLA ensemble 145, can then be incorporated into predictive models capable of receiving user search queries and to output predicted item names including at least one item name from a lexicon associated with the tenant or entity for which the conversational system 700 has been configured and deployed.

Although a few variations have been described in detail above, other modifications or additions are possible. For example, the query classification can be applied directly to search engines to produce more relevant results independently from a conversational system (e.g., in some implementations, the current subject matter need not be applied to a conversational system). The query classification can directly integrate with a search engine and provide additional signals related to the sparse product categories to boost good (e.g., relevant) query results to the top of a result list.

The subject matter described herein provides many technical advantages. For example, some implementations of the current subject matter can increase recall in search engines so that the user will be exposed to more relevant results.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a plurality of search queries including user provided natural language representations of the plurality of search queries of an item catalogue and first labels associated with the plurality of search queries;
determining, using the received data, label weights characterizing a frequency of occurrence of the first labels within the received data;
determining second labels, the determining including removing or changing the first labels from the received data to reduce a total number of allowed labels for at least one search query; and
training a classifier using the plurality of search queries, the second labels, and the determined weights, the classifier trained to predict, from an input search query, a prediction weight and at least one prediction label associated with the prediction weight.

2. The method of claim 1, wherein the determining the second labels includes determining a probability distribution of the second labels, and wherein training the classifier includes using the probability distribution.

3. The method of claim 1, wherein the item catalogue categorizes items by a hierarchical taxonomy, wherein the first labels are categories included in the item catalogue and wherein the first labels are determined based on user behavior associated with the plurality of search queries.

4. The method of claim 3, further comprising pruning the categories in the item catalogue to limit the number of allowed labels, the pruning based on a count of the labels occurring within the received data.

5. The method of claim 1, wherein determining the second labels includes applying a sparsity constraint to the first labels.

6. The method of claim 5, wherein applying the sparsity constraint to the first labels includes computing a metric and removing or changing labels within the first labels that satisfy the metric.

7. The method of claim 5, wherein the second labels are represented as a sparse array.

8. The method of claim 1, further comprising splitting the received data into at least a training set, a development set, and a test set.

9. The method of claim 1, wherein training the classifier includes determining, using a natural language model, contextualized representations for words in the natural language representation, tokenizing the contextualized representations, and wherein the training the classifier is performed using the tokenized contextual representations.

10. The method of claim 9, wherein the tokenized contextual representations are input to a multilayer feed forward neural network with a nonlinear function in between at least two layers of the multilayer feed forward neural network.

11. The method of claim 1, further comprising:
receiving an input query characterizing a user provided natural language representation of an input search query of the catalog of items;
determining, using the trained classifier, a second prediction weight, and a second prediction label;
executing the input query on the item catalogue and using the second prediction weight and the second prediction label; and
providing results of the input query execution.

12. The method of claim 1, wherein the training further includes determining a cost of error measured based on a distance between labels within a hierarchical taxonomy.

13. A system comprising:
at least one data processor; and
memory coupled to the at least one data processor and storing instructions which, when executed by the at least one data processor, cause the at least one data processor to perform operations comprising:
receiving data characterizing a plurality of search queries including user provided natural language representations of the plurality of search queries of an item catalogue and first labels associated with the plurality of search queries;
determining, using the received data, label weights characterizing a frequency of occurrence of the first labels within the received data;
determining second labels, the determining including removing or changing the first labels from the received data to reduce a total number of allowed labels for at least one search query; and
training a classifier using the plurality of search queries, the second labels, and the determined weights, the classifier trained to predict, from an input search query, a prediction weight and at least one prediction label associated with the prediction weight.

14. The system of claim 13, wherein the determining the second labels includes determining a probability distribution of the second labels, and wherein training the classifier includes using the probability distribution.

15. The system of claim 13, wherein the item catalogue categorizes items by a hierarchical taxonomy, wherein the first labels are categories included in the item catalogue and wherein the first labels are determined based on user behavior associated with the plurality of search queries.

16. The system of claim 15, the operations further comprising pruning the categories in the item catalogue to limit the number of allowed labels, the pruning based on a count of the labels occurring within the received data.

17. The system of claim 16, wherein applying the sparsity constraint to the first labels includes computing a metric and removing or changing labels within the first labels that satisfy the metric.

18. The system of claim 16, wherein the second labels are represented as a sparse array.

19. The system of claim 13, the operations further comprising:
receiving an input query characterizing a user provided natural language representation of an input search query of the catalog of items;
determining, using the trained classifier, a second prediction weight, and a second prediction label;
executing the input query on the item catalogue and using the second prediction weight and the second prediction label; and
providing results of the input query execution.

20. A non-transitory computer readable medium storing instructions which, when executed by at least one data processor forming part of at least one computing system, cause the at least one data processor to perform operations comprising:
receiving data characterizing a plurality of search queries including user provided natural language representations of the plurality of search queries of an item catalogue and first labels associated with the plurality of search queries;
determining, using the received data, label weights characterizing a frequency of occurrence of the first labels within the received data;
determining second labels, the determining including removing or changing the first labels from the received data to reduce a total number of allowed labels for at least one search query; and
training a classifier using the plurality of search queries, the second labels, and the determined weights, the classifier trained to predict, from an input search query, a prediction weight and at least one prediction label associated with the prediction weight.
